(19) United States
(12) Patent Application Publication
(10) Pub. No.: US 2016/0110478 A1
(43) Pub. Date: Apr. 21, 2016

(54) SYSTEM AND METHODS FOR QUANTIZATION AND FEATURIZATION OF TIME-SERIES DATA

(71) Applicant: General Electric Company, Schenectady, NY (US)

(72) Inventors: Kareem Sherif Aggour, Niskayuna, NY (US); Andrew Walter Crapo, Scotia, NY (US); Abha Moitra, Scotia, NY (US); Steven Matt Gustafson, Niskayuna, NY (US)

(21) Appl. No.: 14/517,485

(22) Filed: Oct. 17, 2014

(51) Int. Cl. G06F 17/30; G06F 11/30; G06F 11/34

(52) U.S. Cl. CPC G06F 17/30994; G06F 11/3447; G06F 11/3024

(57) ABSTRACT

Embodiments allow blocking and featurization of time-series data gathered from at least one sensor. The input time-series data is divided into blocks with common attributes (features) according to feature models that describe patterns in the data. The blocks may be overlapping or non-overlapping. The resultant feature blocks are annotated with feature information and semantic meaning. The feature blocks can be indexed to facilitate semantic search of the data. Feature blocks may be further analyzed to create semantic blocks that incorporate semantic meaning and features for multiple feature blocks, sensors and/or related time-series data. The semantic blocks can also be indexed to facilitate semantic search of the data.

### TECHNICAL FIELD

Embodiments pertain to processing industrial data. More specifically, embodiments incorporate semantic meaning into industrial data.

### BACKGROUND

As small, inexpensive sensors have become ubiquitous in recent years, there has been a veritable explosion in the amount data being generated and collected from industrial equipment, environmental sensors, and other such sources. These represent examples of industrial data where sensors measure real world parameters such as temperatures, pressures, and more. The vast amount of data being produced creates challenges in effectively searching and mining the massive quantities of time-series data.

### BRIEF DESCRIPTION OF THE DRAWINGS

FIG. 1 illustrates an example architecture for blocking, featurization and semantic annotation of time-series data.

FIG. 2 illustrates an example architecture for blocking and featurization of time-series data.

FIG. 3 illustrates an example of overlapping featurized blocks in an example embodiment.

FIG. 4 illustrates an example of a flow diagram for blocking and featurization of time-series data.

FIG. 5 illustrates an example of information in a feature block in a representative embodiment.

FIG. 6 illustrates an example architecture for semantic annotation of featurized blocks.

FIG. 7 represents an example flow diagram for semantic annotation of featurized blocks.

FIG. 8 represents example data fields in a semantically annotated block in a representative embodiment.

FIG. 9 illustrates a system block diagram of an example system according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Various modifications to the embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that embodiments of the invention may be practiced without the use of these specific details. In other instances, well-known structures and processes are not shown in block diagram form in order not to obscure the description of the embodiments of the invention with unnecessary detail. Thus, the present disclosure is not intended to be limited to the embodiments shown, but is to be accorded the widest scope consistent with the principles and features disclosed herein.

As small, inexpensive sensors have become ubiquitous in recent years, there has been a veritable explosion in the amount data being generated and collected from industrial equipment, environmental sensors, and other such sources. These represent examples of industrial data where such sensors measure real world parameters such as temperatures, pressures, and more. The vast amount of data produced creates challenges in effectively searching and mining the massive quantities of time-series data. Searching and mining time-series data enables, among other things, root-cause analysis to understand why a fault has occurred, identifying opportunities to increase performance of a piece of equipment, a process, and so forth, understanding how interactions between various measured parameters correlate to particular desired or not desired outcomes (e.g., failure analysis, productivity analysis, and so forth), and other such activities. As used herein, time-series data means data having an associated time stamp or other time-identifying information, such as would be available from one or more sensors. The time between measured data points need not be uniform.

Identifying patterns and/or semantic meaning associated with time-series data allows searching to incorporate semantic concepts and greatly increases the success of activities such as those listed above. Semantic meaning helps to associate concepts from a particular domain to the data. For example, increasing temperature in a pressure vessel can have different meanings (or multiple meanings) depending on the particular context. In one context, it may represent a potentially dangerous situation. In another context it may represent an efficiency gain. Identifying patterns and/or associating semantic meaning helps to extract information from the data.

Embodiments disclosed herein relate to identifying patterns in and/or associating semantic meaning with time-series data. Embodiments group or “block” the data into discrete blocks and extract and store relevant features of the blocks. The approach reduces the volume of data and by pre-calculating, storing and indexing features of the blocks, enables efficient search and analysis. By leveraging semantic technologies, the blocks can be associated with domain knowledge regarding how to understand and leverage time-series data in general and in the context of specific background knowledge of the domain to enable the discovery of actionable insights. Some embodiments use recognition methods to identify new patterns of block differentiation, thereby identifying candidate extensions to a classification hierarchy of block types. A single sequence of time-series data can be divided into blocks in different ways to serve different objectives, all depending on the application and search requirements for the data.

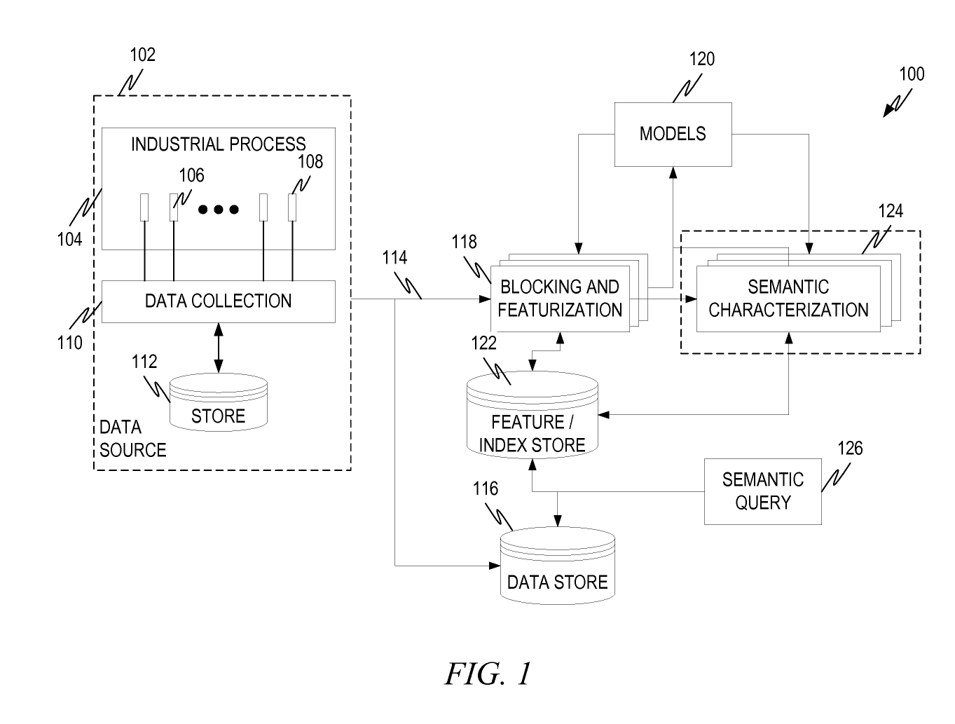

FIG. 1 illustrates an example architecture 100 for blocking, featurization and semantic annotation of time-series data. The architecture 100 receives time-series data from a data source, such as the data source 102. The data source 102 represents any time-series data. Typically the data source stores time-series data that has been previously collected, but such is not required. The data source typically includes time-series data collected from one or more sensors 106, 108 that measure real world information such as through an industrial process 104. The industrial process 104 includes, but is not limited to, a manufacturing process, power generation equipment/processes, machines of all types, alarm systems, weather sensors, engines, turbines, and so forth. Thus, the illustrated industrial process 104 serves as a general description for any real-world system or process where time-series data is measured/generated.

Often the data measured/collected from the industrial process 104 is collected in some sort of data collector and/or concentrator 110 before being stored in some sort of data store 112. The data collector 110 represents any type of mechanism that receives data from sensors 106, 108 and then stores the data. In some embodiments the data collector 110 also provides a time stamp for the data. In other embodiments, the sensors 106, 108 or some other system component will provide time stamp data.

The architecture 100 also comprises at least one model as illustrated by models module 120. As explained in greater detail below, in the illustrated architecture, models module 120 represents both pattern model(s) used by blocking and featurization module(s) 118 and semantic model(s) used by semantic characterization module(s) 124. The semantic characterization module(s) 124 are surrounded by a dashed box to indicate that they are optional in the architecture. The models represented by model module 120 are used as input into pattern matching and other methods that determine the features, characteristics, semantic aspects and so forth of input time-series data as explained below.

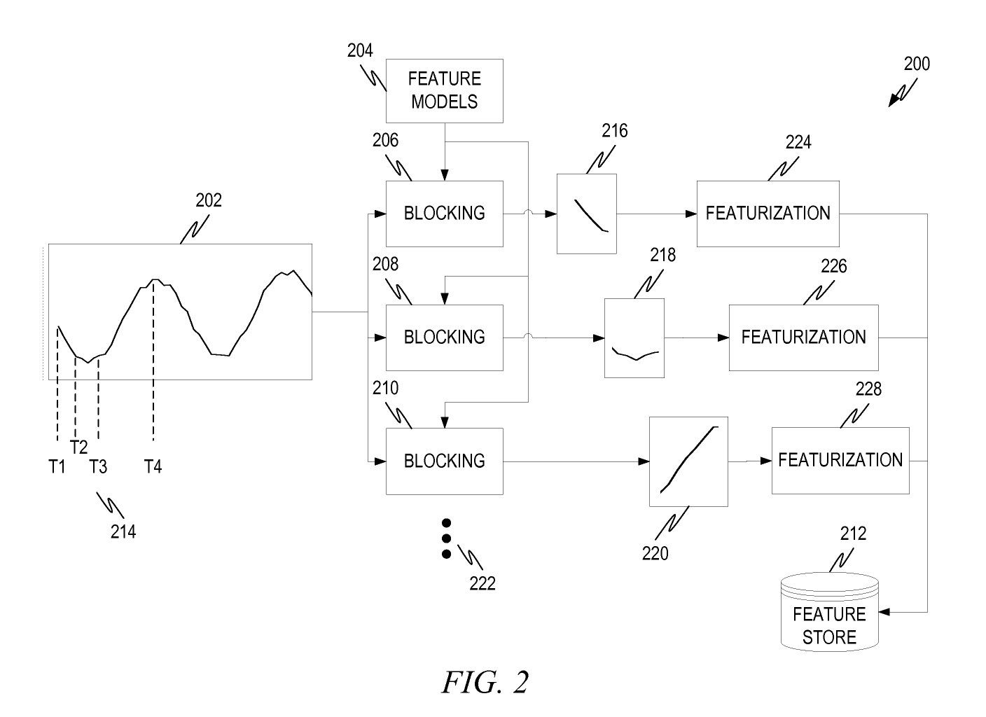

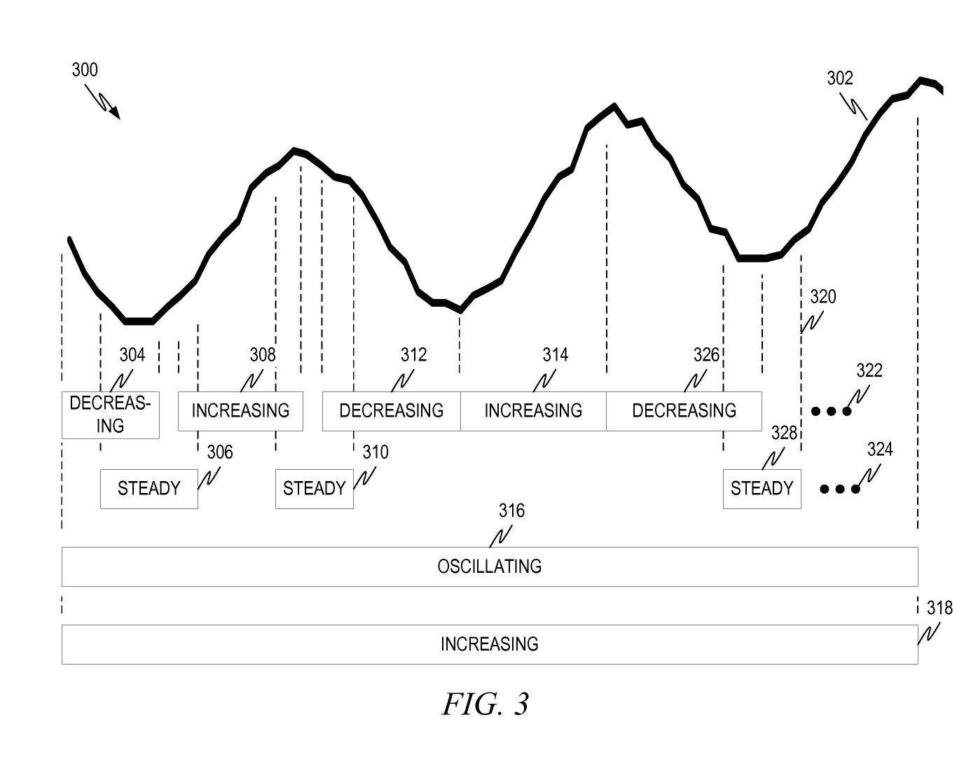

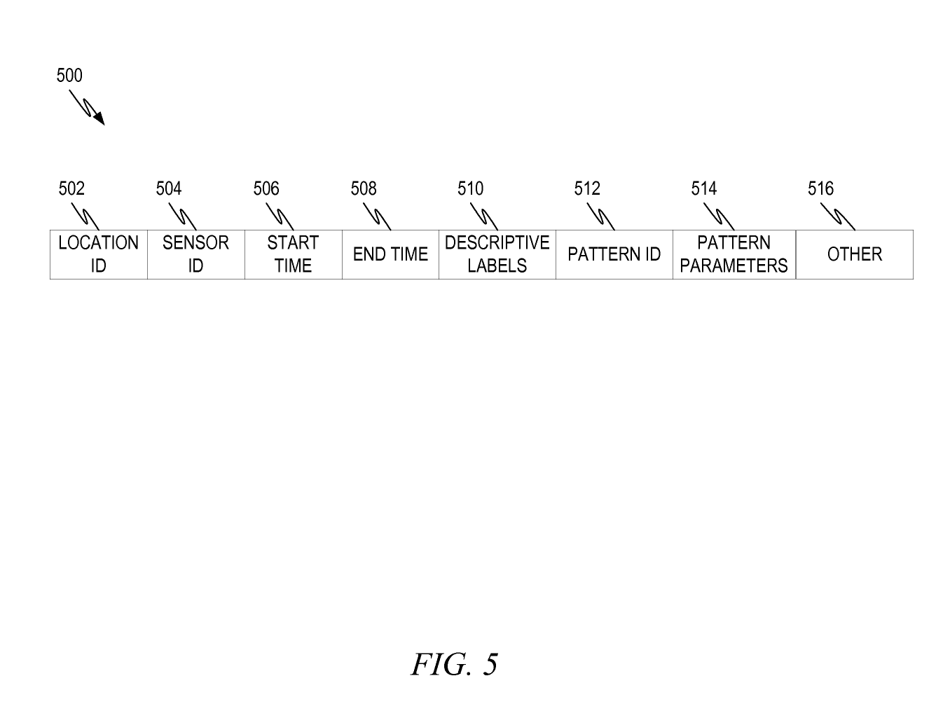

Blocking and featurization module(s) 118 divide the input time-series data 114 into feature blocks and associate various types of information that describe aspects of the feature blocks. The feature blocks are determined by matching the input time-series data 114 to patterns described in feature models (sometimes referred to as pattern models) from the model module 120. The feature blocks can include information about the feature (or pattern) that the block contains, identifying information about the time-series data, as well as semantic information and/or descriptive labels. Representative information contained in feature blocks are illustrated and discussed in conjunction with FIG. 5 below. Representative patterns and mechanisms for featurization are described and illustrated in conjunction with FIGS. 2 and 3 below.

Blocking and featurization module(s) 118 also looks for patterns that do not match any of the pattern models. When such patterns are encountered, a potential new pattern can be outputted for incorporation into the models module 120. In some embodiments, these patterns are identified and added automatically. In other embodiments, a potential pattern is identified for a user to review and, if desired, added to the models module 120. Identification of potential patterns may also include identification of parameters (sometimes referred to as properties) associated with the potential pattern. In embodiments which incorporate this functionality, the embodiments identify parameters that are desired to characterize the key features of the pattern. For example, if a new potential pattern is identified that can be represented by a particular B-Spline, the parameters identified can include the degree of the basis function(s) and the coefficients that should be determined based on the time-series data. The capability to identify potential new patterns is illustrated by the arrow from the blocking and featurization module(s) 118 to models module 120.

As described below, the output of the blocking and featurization module(s) 118 include discrete feature blocks. Since a particular sequence of time-series data can be blocked in many different ways to server different objectives, the time-series data can be blocked in overlapping and/or non-overlapping feature blocks. Similarly, multiple feature blocks can be used to describe a given sequence of time-series data. Examples are discussed below. Representative feature blocks are discussed below in conjunction with FIG. 5.

The feature blocks from the blocking and featurization module(s) 118 are stored in a data store such as feature/index data store 122 in some embodiments. The stored feature blocks can then be retrieved for further analysis, indexing, and so forth, such as by the semantic characterization module(s) 124 or an indexer (not shown). Additionally, or alternatively, feature blocks can be provided directly to such modules as semantic characterization module(s) 124 and/or an indexer (not shown).

The architecture 100 may also comprise one or more semantic characterization module(s) 124. The semantic characterization module(s) 124 add a layer of semantic description to the feature blocks. The semantic layer added by semantic characterization module(s) 124 combines the information from multiple-time series data with domain knowledge to create a better understanding of the data and to enable better insights and understanding. More specifically, the feature blocks created by blocking and featurization module(s) 118 are evaluated against semantic models from models module 120 in order to create semantic blocks that can tag the data with appropriate semantic information.

As an example, consider a plurality of pressure sensors located in a radial dimension of a steam turbine. The pressure sensors combined yield a radial pressure gradient. Further, suppose that when the time-series data from the pressure sensors are evaluated by blocking and featurization module(s) 118, the first (e.g., closes to the central axis of the turbine) sensor is identified as having an increasing pressure pattern. The second (e.g., next sensor along the radial dimension) sensor has a more slowly increasing pressure pattern. The third (e.g., next sensor along the radial dimension) sensor has a constant pressure pattern. The blocking and featurization module(s) 118 thus identify feature blocks having these patterns. The semantic characterization module(s) 124 then evaluate the three blocks against a semantic pattern that states when these three patterns occur in conjunction with each other, a problem exists with the inlet steam. Thus, the semantic characterization module(s) 124 can create a semantic block identifying the relevant feature blocks and tagging the semantic block with appropriate semantic information.

The semantic characterization module(s) 124 also identify potential new patterns in some embodiments. This can function as previously described in conjunction with possible new patterns identified by the blocking and featurization module(s) 118. Thus, in some embodiments, the semantic characterization module(s) 124 automatically identify the potential patterns, create the semantic model(s), and make them accessible through the models module 120. In other embodiments, the semantic characterization module(s) 124 identify the potential patterns and make them available for further analysis by a user, who then makes the new semantic models accessible through the models module 120.

Feature blocks and/or semantic blocks are indexed in some embodiments to create one or more semantic indexes that can be queried by the semantic query module 126. Indexing feature blocks and/or semantic blocks can be accomplished in any conventional manner that allows the information from the blocks to be searched by the semantic query module 126. The semantic query module 126 is a module, engine, system or other such entity that allows queries to be run across the blocks.

In architecture 100, the data store 116 represents storage of the underlying time-series data. The data store 116 can be the same as, or different from the data store 112. Having both the blocks (e.g., feature and/or semantic blocks) available as well as the underlying time-series data allows a user querying the information to start at a higher level (semantic level or block and feature level) and then drill down to the underlying raw time-series data if desired. As a representative example only, a user may submit a query such as “find time periods were the thermocouple temperatures in the cracking tower indicated potential problems.” The semantic query module 126 then evaluates the semantic blocks and/or underlying feature blocks to identify those time periods with potential problems. The time periods can then be presented to the user along with descriptions of the potential problem(s). In response, the user may drill down into the details of the semantic blocks, the feature blocks and/or time-series data.

FIG. 2 illustrates an example architecture 200 for blocking and featurization of time-series data. The architecture 200 is a representative embodiment of the blocking and featurization module(s) 118 of FIG. 1. Data input 202 represents the time-series data that is to be divided into blocks and featurized. The time-series data can come from any appropriate source, such as a data store or from a data collector. The time-series data typically comes from a single sensor at this point, but time-series data that is derived from a combination of sensors can also be used, such as data representing an average temperature from a plurality of sensors measuring temperature.

Dividing the data into blocks is accomplished by recognizing common characteristics of the input data, typically over some period of time. A single window of raw time-series data can be divided into an arbitrary number of blocks of arbitrary duration. One method to divide the time-series data into blocks is to look for patterns in the data that define the common characteristics. Thus, the architecture 200 includes one or more feature models 204. The feature models 204 are patterns or other characteristics that are used to identify the common characteristics in the input time-series data. Examples of the feature models 204 include any combination of “steady-state,” “increasing,” “decreasing,” “oscillating,” and/or combinations thereof. Steady-state describes a constant value. Increasing describes some sort of increasing value and decreasing describes some sort of decreasing value. Increasing and/or decreasing do not have to be linearly increasing or decreasing. Oscillating describes variation at one or more frequencies. These patterns are simply examples, and other patterns may also be used.

The system can automatically classify blocks based on the characteristics and/or trends in the time-series data. In the example embodiment of FIG. 2, dividing into blocks (e.g., classifying into blocks) is performed by blocking modules 206, 208 and 210, which may each look at whether the time-series data matches one or more feature model patterns. The illustrated embodiment may also have additional blocking modules as indicated by ellipses 222. Alternatively, or additionally, rather than have different blocking modules each looking for different patterns, a single blocking module may be used that looks for multiple patterns.

As an example of the illustrated embodiment, consider that blocking module 206 looks for a decreasing pattern, blocking module 208 looks for a steady-state pattern and blocking module 210 looks for an increasing pattern. Examining the input time-series data 202, from time T1 to T2, the data is generally decreasing, from time T2 to T3, the data is generally steady state (or at least has some average value there) and from time T3 to T4 the data is generally increasing. Of course, other patterns exist in the input time-series data 202. For example, the time series data also oscillates and/or may also have other patterns that could be matched.

Continuing with the example, blocking module 206 identifies the decreasing value from T1 to T2 as indicated by block 216, which is a pictorial diagram of the block that is identified by blocking module 206 from T1 to T2. In general, blocks would not be identified pictorially, however such is not precluded by embodiments of the disclosure. Similarly, blocking module 208 detects the steady-state pattern between T2 and T3 as indicated by block 218 and blocking module 210 identifies the increasing pattern between T3 and T4 as indicated by block 220.

Once the data has been divided into blocks, features are added to the blocks to create feature blocks. Features, which can also be referred to as properties, attributes, and so forth, are information that describe the characteristics of the block. Features can fall into categories, such as features that are mandatory for a particular pattern and features that are optional for a particular pattern. What features are mandatory and what features are optional depends on the implementation and some implementations may have no optional features (e.g., all mandatory features) and some implementations may have no mandatory features (e.g., all optional features). Features may also be categorized based on what they describe. For example, features that describe the pattern may be considered to be pattern features and include such information as some measure of the slope of increase or decrease (minimum, maximum, linear, exponential, geometric, and so forth), a measure of the steady-state value (average value, and so forth), one or more properties that describe oscillation (e.g., minimum, maximum, average, amplitude, frequencies, and so forth). Features that are descriptive of what the data and/or patterns mean can be considered to be semantic features and can include descriptive labels that are related to the semantics of the data. Returning to a variation of a prior example, if a temperature sensor is increasing at a particular rate, a potential problem may be occurring. The semantic features for that feature block can describe the potential problem, the related causes, and/or whatever else is desired. Time features can describe things like start time, length (e.g., duration), stop time and so forth. Other features can describe things like the identifier (ID) of the sensor, sensor type (e.g., temperature, pressure, and so forth), location of the sensor (e.g., machine ID, location within the process, relationship to other sensors, and so forth), and so forth. Features are discussed in greater detail in conjunction with FIG. 5 below.

Featurization modules 224, 226, and 228 are representative implementations that take the identified block and add the desired features to create the feature blocks. The feature blocks can then be stored for later retrieval and/or analysis if desired.

In addition, although not specifically illustrated in FIG. 2, the blocking modules 206, 208, 210 can identify new patterns in the input time-series data 202 that do not match any of the existing feature models provided by feature model 204. When a potential new pattern has been identified, the pattern can either be included in feature models 204 or the pattern can be identified so that the pattern can undergo further analysis to identify whether a new pattern exists, and if so, whether it should be added to feature models 204.

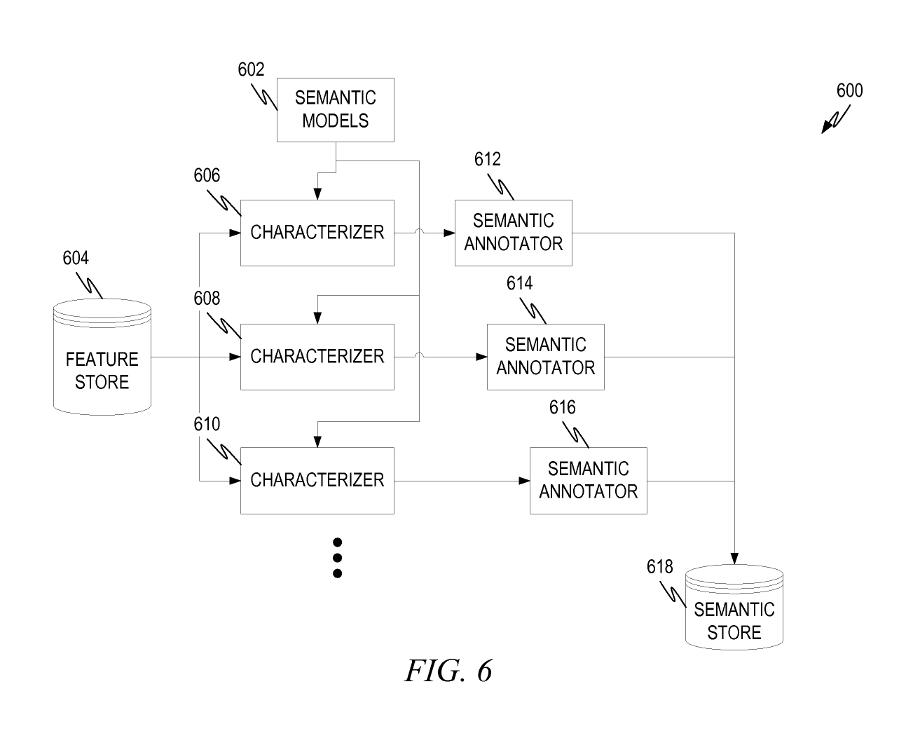

The feature blocks can be indexed to create an index that allows semantic searching of the feature blocks. At this level, the semantic information associated with the data is at the feature block level. In other words, the semantic information is often on a sensor-by-sensor basis. Thus, semantic queries can search for patterns within a sensor or across multiple sensors using the individual sensor semantic information. As explained below in conjunction with FIGS. 6-8, semantic information can also be included in a cross-sensor scenario.

FIG. 3 illustrates an example of overlapping featurized blocks in an example embodiment. The example, illustrated generally as 300, shows time-series data 302. This time-series data 302 has multiple possible patterns that can be recognized and/or featurized at different levels. The dashed lines (e.g., 320) show the beginning and ending of various representative blocks. The ellipses 322, 324 show that more blocks could be identified and featurized in this example. However, the blocks identified and discussed below are sufficient to illustrate the principles involved.

As illustrated, the time-series data 302 is generally oscillating at one or more frequencies while, at the same time, the average value is steadily increasing. The following represents illustrative examples of feature blocks that can be identified from the patterns. The blocks can be overlapping, non-overlapping, or combinations thereof as discussed below.

As examination of the time-series data 302 begins, the values are generally decreasing. Thus, a decreasing feature block 304 can be identified as illustrated. Overlapping with the decreasing feature block 304 can be the steady-state feature block 306. Although the value decreases slightly and then increases slightly over the identified time period, a pattern match method could identify that as a steady-state pattern and identify feature block 306. Similarly, the overlapping increasing feature block 308 and steady-state feature block 310 can be identified, as previously described above.

The overlapping nature of feature blocks 304, 306, 308, 310 and 312 illustrate that there are numerous ways that a time-series data segment can be divided into feature bocks and numerous patterns that can be identified in a given time-series segment.

The example of FIG. 3 also illustrates non-overlapping feature blocks such as the decreasing feature block 312, the increasing feature block 314 and the decreasing feature block 326. These feature blocks illustrate that not all identified feature blocks may be overlapping in all situations.

Some patterns may emerge after a relatively short period of time (such as feature blocks 304, 306, 308, 310, 312, 314, 326 and 328) while other patterns may only emerge after a relatively longer period of time. Two such feature blocks are illustrated by the oscillating feature block 316 and the increasing feature block 318. The oscillating feature block 316 identifies the oscillating nature of the input time-series data 302, while the increasing feature block 318 identifies the rise in average value of the input time-series data 302.

When longer-term trends are identified such as with feature blocks 316 and 318, the shorter time frame blocks may be replaced by the longer term feature blocks (e.g., feature blocks 316 and 318 replacing feature blocks 304, 306, 308, 310, 312, 314, 326, and 328) or both can coexist simultaneously.

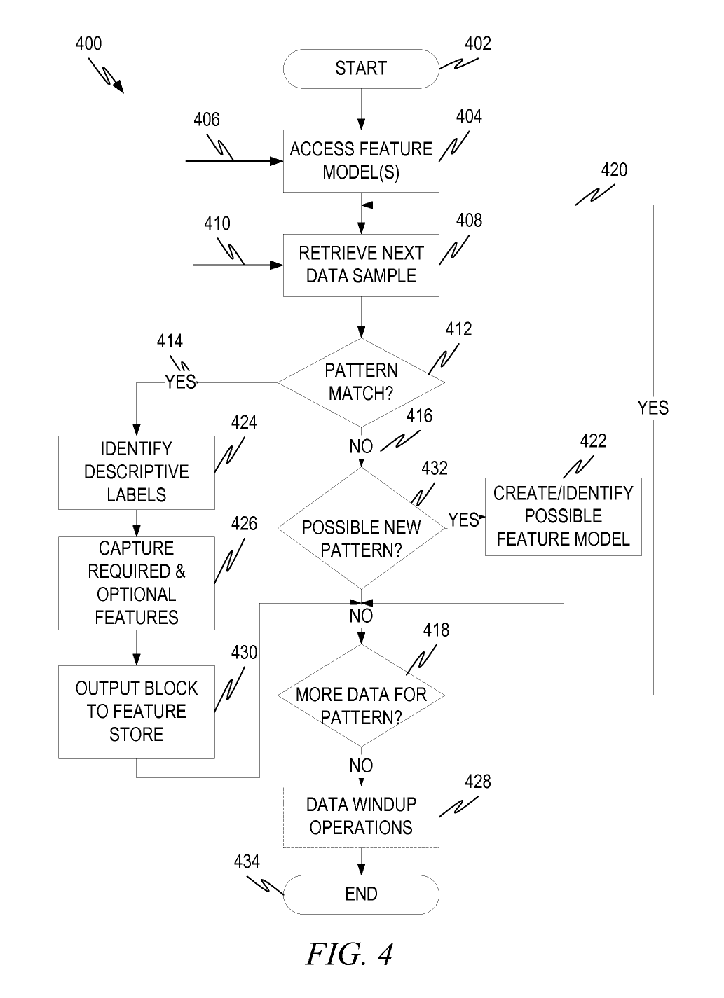

FIG. 4 illustrates an example of a flow diagram 400 for blocking and featurization of time-series data. The method starts at operation 402 and proceeds to operation 404 where the system accesses the feature model(s) that are used to look for patterns within the input time-series data. This access is indicated by arrow 406. As described previously, the feature models can include patterns that are used to identify various features in the time-series data.

At operation 408, the next data sample in the time-series data is retrieved as indicated by arrow 410. Decision block 412 tests whether a pattern (e.g., feature) has been identified in the data based on retrieval of the last data sample. In other words, including the last data sample, are any features apparent in the data that has been retrieved. Discussion of using the feature models to perform this function exist above. However, various implementations can be used in order to determine whether given patterns are found within the data such as neural network techniques where data is applied to the input of a trained neural network and the output defines whether a given pattern has been matched. Alternative implementations can use curve fitting, Bayesian methods, least squares type methods or other such pattern determination methods. Pattern matching methods are known in the art and can be applied in this context.

If no features have yet been determined, the “no” branch 416 is taken and operation 432 determines if the data point has yielded a possible new pattern. If a possible new pattern has been determined, then the system will behave in different ways, depending on the embodiment. All of these behaviors are indicated by operation 422 which shows that the system will create and/or identify the possible new feature model. In one embodiment, the system can automatically take the pattern and prepare it for use as a feature model. The specific operations needed to do this will depend on the implementation of the feature models. For example, if a new potential pattern is identified that can be represented by some geometric equation, curve fit, correlation or other way to describe the pattern, the feature model is created by identifying parameters that describe the pattern. As a representative example, if the pattern is represented by a B-Spline, the parameters identified can include the degree of the basis function(s) and the coefficients that should be determined based on the time-series data. In other embodiments, the system outputs information on the potential new pattern and allows a user to determine if and how a feature model should be created from the potential new pattern. Even if an embodiment has the ability to automatically determine a feature model, the embodiment may wait for user approval before incorporating said feature model into the set of feature models used to identify feature blocks. After operation 422, the system checks for the next data sample, if any, in operation 418.

Operation 418 determines if more data exists in the time series data. If so, the “yes” branch 420 is taken and the system continues to look for features in the data. If not, the system optionally determines what to do with any remaining data that has not been assigned to a feature block in operation 428. For example, perhaps there is not enough data to identify any features in the data and/or determine that a new pattern may exist. In this situation, some embodiments drop the “tail end” data not assigned to a feature block from further consideration. In other embodiments, one or more of the last feature blocks are checked to see if the remaining data should be assigned to one or more of the most recent feature blocks. In these embodiments, the system can also optionally re-featurize the feature block (e.g., execute operations 424, 426 and/or 430) in order to see if the added data changes any of the captured characteristics. Once these optional steps are performed (if any) the data is complete and the method ends as indicated by operation 434.

Operations 408, 412, 418 and 432 represent the blocking operations, and as such, are an example implementation of a blocking module, such as blocking modules 206, 208, 210 and so forth.

If a feature is detected in operation 412, then the “yes” branch 414 is taken and the feature block is featurized in the next few operations. Operations 424, 426 and/or 430 represent an example embodiment of a featurization module, such as featurization module 224, 226, 228 and so forth.

In operation 424 descriptive labels are added to the feature block that are descriptive of the features and/or incorporate semantic meaning into the feature block. For example, when the average exhaust temperature from a ring of sensors in a gas turbine increases at a rate that exceeds a given threshold without a commensurate increase in the exhaust air speed, it indicates a potential pressure buildup within the equipment. The descriptive label can include the semantic meaning (e.g., a problem or potential problem within the turbine) and optionally any conditions, patterns and/or other relevant information (e.g., when the identified feature block is increasing and the rate of increase exceeds a given threshold while another feature block is in steady-state). An example of the descriptive label(s) that describes the feature would be the second portion of the above (e.g., a description of the pattern along with any conditions if desired such as “increasing” and/or the threshold value) or any other such description.

Operation 426 captures any additional required and/or optional features. Examples of required and/or optional features are discussed below in conjunction with FIG. 5.

Operation 430 outputs the feature block to a data store such as a feature or other store for later retrieval and/or analysis. Additionally, or alternatively, the system can send the feature blocks to another program, method, system, and so forth. Thus, the feature blocks are indexed for semantic search in some embodiments of the disclosure. After operation 430, the system checks for the next data sample, if any, in operation 418.

FIG. 5 illustrates an example of information (e.g., features, attributes, characteristics and so forth) in a feature block 500 in a representative embodiment. The information can be variously referred to as “features,” “properties,” “attributes” and so forth. The features illustrated in feature block 500 can be either optional or required in various embodiments. Typically, although not always, required features comprise some combination of identification of the source of the data, the time segment of the feature block, and descriptive label(s). Typically, although not always, optional features comprise information that describes the feature pattern.

Features that identify the source of the data can be any type of information that describes where the data originates. In the representative example of FIG. 5, the features that identify the source of the data comprise a location ID 502, which describes the location of the sensor such as a machine or unit ID (e.g., welder X5B), location within the system (e.g., oil inlet 5), and/or any other such identifying information. The features that identify the source of the data also comprise a sensor ID 504, which is an identifier for the particular sensor(s) that generated the time-series data.

Features that identify the time segment of the feature block can comprise any identifiers that define where the block is located within the time-series data. This can be, for example, a time reference, a sample number or any other such identifier. An example is a start time along with a duration and/or end time. In the representative example of FIG. 5, the features that identify the time segment comprise the start time 506 and the end time 508.

Descriptive label(s) such as the descriptive label 510 have been previously discussed and typically comprise any labels that are descriptive of the feature block and/or incorporate semantic meaning into the data.

Examples of features that describe the feature pattern can include a label such as “increasing” or “oscillating” or some other pattern ID. This is indicated in the example of FIG. 5 by the pattern ID 512. The pattern may also need additional information to describe it as illustrated by the pattern parameter(s) 514. Some examples of pattern parameters 514 include, but are not limited to, a minimum value, a maximum value, an average value, a slope value, an amplitude, one or more frequencies, and/or so forth either singly or in any meaningful combination. The different patterns will have different information to specify the patterns and those skilled in the art will be able to quickly identify which features should be used to describe a particular pattern.

In FIG. 5, other feature 516 represents any additional features (optional and/or required) that are included in the feature block.

FIG. 6 illustrates an example architecture 600 for semantic annotation of featurized blocks. As previously discussed, feature blocks can contain semantic information (e.g., descriptive labels and/or other semantic information). However, feature blocks represent features of a single time-series, such as data from a single sensor or data from multiple sensors that have been combined into a single series (e.g., linear combination of time-series data from multiple sensors, average values, and so forth). However, there is another semantic level that exists when multiple feature blocks are considered from multiple sensors. As an example, in a wind farm used to generate power from wind, wind speed sensors at various elevations can measure the wind speed gradient. Wind speed gradient in combination with data from other sensors such as barometric pressure, temperature, and so forth, may have some semantic meaning when considered all together. Thus, embodiments disclosed herein may, but not necessarily, include a larger “semantic annotation” loop that annotates feature blocks from multiple time-series data. This semantic annotation loop was illustrated, for example as the optional semantic characterization modules 124 of FIG. 1. Architecture 600 represents an example embodiment of such semantic characterization modules.

Feature blocks from multiple time-series data are stored in the feature store 604. These represent the feature blocks that will be searched for cross-time-series data semantics. Additionally, or alternatively, the feature blocks to be considered may come from a different source, such as from a blocking and featurization module. In alternate embodiments, the architecture takes the underlying time-series data as input rather than the feature blocks created from the underlying time-series data. In still further embodiments, both the underlying time-series data and the feature blocks created from the underlying time series data are used as input.

Semantic model module 602 provides the semantic models that are used to identify semantic meaning across feature blocks. The semantic models can be implemented in a similar fashion to the feature models previously discussed, such as via patterns that occur in feature blocks across sensors. As an example, if one feature block from a temperature sensor is rising while another feature block from a pressure sensor is falling, then that may indicate a leak in a pump housing. This is semantic meaning in the data that can be identified by looking for a rising pattern in the temperature feature blocks and a falling pattern in the pressure feature blocks for identified sensors. As with feature models, specific parameters of the identified feature block may be analyzed to see what semantic meaning should be associated. Thus, in the example above, a falling pressure may not be sufficient by itself. The falling pressure needs to drop below a particular absolute pressure before the falling pressure and rising temperature indicate a leak in a pump housing.

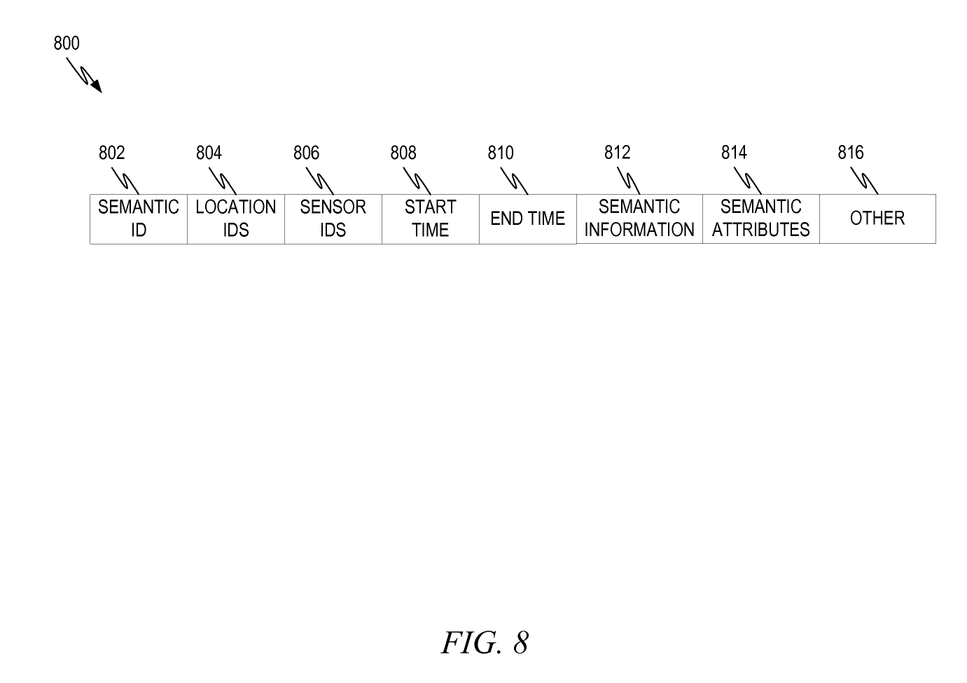

The models are accessed by the characterizer blocks 606, 608, 610 and so forth to determine when the appropriate feature blocks match the semantic model. Matching feature blocks are represented by a semantic block, an example of which is discussed in conjunction with FIG. 8. Thus the output of characterizer modules 606, 608, 610 and/or so forth are semantic blocks that have not yet been annotated.

Matching feature blocks to a semantic model may not only include identifying particular patterns (as in the examples above), but may also require a particular time relationship between the feature blocks. In the example above, the pressure falling and temperature rising may need to have a particular time relationship (e.g., the pressure falls by some amount and the temperature increases by another amount within so many minutes of the pressure falling in order to indicate a leak in the pump housing). Thus, pattern matching may be accompanied by time shifting in order to declare that a set of feature blocks match the semantic model. As before, the pattern matching and/or time shifting can be accomplished by any number of methods, including neural networks, Bayesian methods, curve fit methods, least squares methods, and so forth. Also, a characterizer module may be looking for a single semantic model match or may be looking for multiple semantic model matches. Thus, the three characterizer modules of FIG. 6 are simply a representative embodiment.

As discussed above in conjunction with the blocking of the feature blocks, semantic blocks identified when the input feature blocks match one or more semantic models can be overlapping, non-overlapping, or any combination thereof. Also, some semantic models may require less time (e.g., fewer feature blocks) than others so there can be shorter semantic blocks existing in conjunction with or replaced by longer semantic blocks.

When one of the semantic patterns is matched, a semantic annotator module, such as semantic annotation modules 612, 614, 616 and/or so forth, annotates the semantic blocks identified by the characterizer modules 606, 608, 610. Semantic annotations are similar to the descriptive labels previously discussed in conjunction with feature blocks, except that they apply to semantic blocks rather than individual feature blocks. As discussed below in conjunction with FIG. 8, semantic annotations comprise semantic information and/or semantic attributes. Semantic annotations can describe the characteristics of the semantic block and/or attach semantic meaning to the block. The characteristics of the semantic block can include, for example, description(s) of the pattern(s) that are indicated by the semantic model or some identifier associated with such patterns. In the example given above, the model looked for a rising temperature and a falling pressure. The description and/or identifier associated with a rising temperature and falling pressure could be part of the descriptive characteristics. The semantic meaning (e.g., semantic information) could be a descriptive label, identifier, or other information that indicates the meaning associated with the rising temperature and falling pressure (e.g., a leak in a pump housing in the example above).

Once the identified semantic blocks have been appropriately annotated, they are stored for later retrieval (e.g., in semantic store 618) and/or sent to another entity for further processing and/or consideration (not shown). In one embodiment, the semantic blocks are indexed so that it is easier to do semantic searching on the semantic blocks.

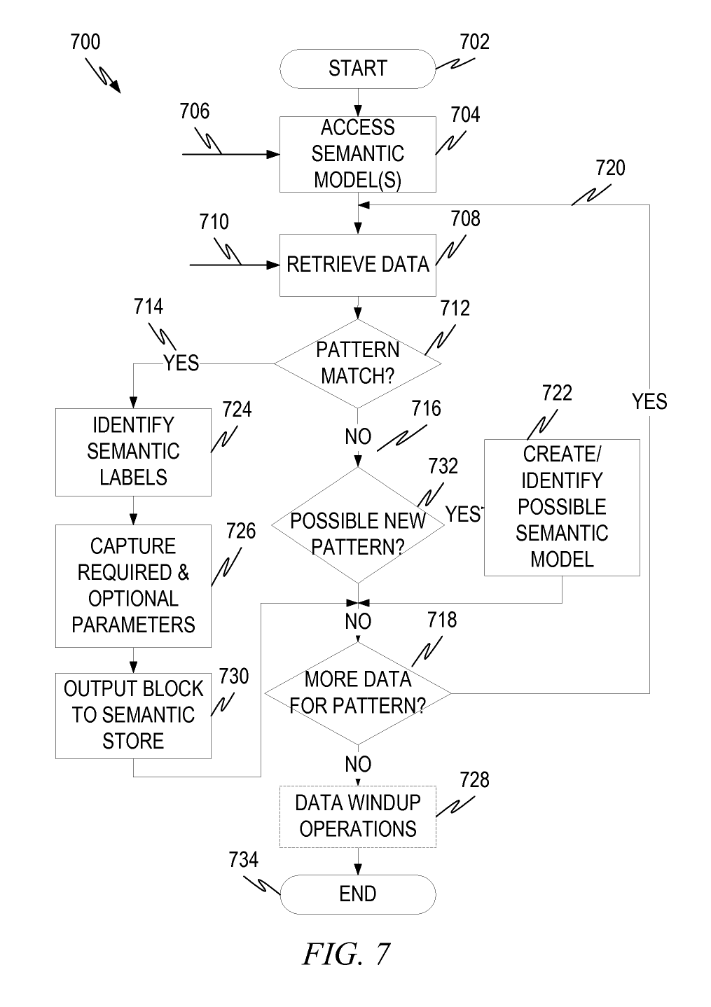

FIG. 7 represents an example flow diagram 700 for semantic annotation of featurized blocks. The method starts at operation 702 and proceeds to operation 704 where the system accesses the semantic model(s) that are used to look for patterns within the input feature blocks. This access is indicated by arrow 706. As described previously, the semantic models can include patterns that are used to identify various features in the feature blocks associated with different time-series data. Thus, accessing feature blocks includes accessing feature blocks that describe multiple time-series data, such as temperature from one sensor and pressure from another (as described in examples above).

At operation 708, the next feature block(s) are retrieved as indicated by arrow 710. Operation 712 tests whether a pattern has been identified in the data based on retrieval of the feature block(s). In other words, including the last retrieved feature block(s), are any semantic patterns apparent in the data that has been retrieved. Discussion of using the semantic models to perform this function exist above. However, various implementations can be used in order to determine whether patterns from the semantic models are found within the data such as neural network techniques where data is applied to the input of a trained neural network and the output defines whether a given pattern has been matched. Alternative implementations can use deductive or abductive reasoning curve fitting, Bayesian methods, least squares type methods or other such pattern determination methods. Pattern matching methods are known in the art and can be applied in this context. Some representations of the semantic model may be graph-theoretic and graph methods may also be useful in identifying patterns in the data that align with the ontology. Since the semantic patterns can occur across multiple feature bocks associated with multiple time-series data, correlation methods can also be used where correlation across feature blocks from the same or different sensors are correlated to identify the semantic pattern(s) of the model(s). Also as previously explained, identifying patterns may involve shifting feature blocks in time in some instances and/or accounting for time differences between feature blocks.

If no semantic patterns have yet been determined, the “no” branch 716 is taken and operation 732 determines if a possible new pattern exists in the data that has been examined. If a possible new pattern has been determined, then the system will behave in different ways, depending on the embodiment. All of these behaviors are indicated by operation 722, which shows that the system will create and/or identify the possible new feature model. In one embodiment, the system can automatically take the pattern and prepare it for use as a semantic model. The specific operations needed to do this will depend on the implementation of the semantic models. For example, if a new potential pattern is identified that can be represented by some geometric equation, curve fit, correlation pattern or other way to describe the pattern, the feature model is created by identifying parameters that describe the pattern. As a representative example, if the pattern is described by a linear curve fit on one feature block and a B-Spline on another feature block, the parameters identified can include the coefficients to be determined for the linear equation for the one feature block and the degree of the basis function(s) and the coefficients that should be determined based on the other feature block.

In other embodiments, the system outputs information on the potential new pattern and allows a user to determine if and how a semantic model should be created from the potential new pattern(s). Even if an embodiment has the ability to automatically determine a semantic model, the embodiment may wait for user approval before incorporating said semantic model into the set of semantic models used to identify semantic blocks.

After operation 722, the system checks whether more feature block(s) exist for evaluation in operation 718. If so, the “yes” branch 720 is taken and the system continues to look for semantic blocks. If not, the system optionally determines what to do with any remaining data that has not been assigned to a semantic block in operation 728. For example, perhaps there is not enough data to identify any patterns in the data and/or determine that a new pattern may exist. In this situation, some embodiments drop the “tail end” data not assigned to a semantic block from further consideration. In other embodiments, one or more of the last semantic blocks are checked to see if the remaining data should be assigned to one or more of the last the semantic blocks. In these embodiments, the system can also optionally re-annotate the semantic block (e.g., execute operations 724, 726 and/or 730) in order to see if the added data changes any of the captured characteristics. Once these optional steps are performed (if any) the data is complete and the method ends as indicated by operation 734.

Operations 708, 712, 718 and 732 represent the characterization operations, and as such, are an example implementation of a characterizer module, such as characterizer modules 606, 608, 610 and so forth.

If a pattern is detected in operation 712, then the “yes” branch 714 is taken and the semantic block is annotated in the next few operations. Operations 724, 726 and/or 730 represent an example embodiment of an annotation module, such as annotation module 612, 614, 616 and so forth.

In operation 724 semantic labels are added to the semantic block that are descriptive of the features and/or incorporate semantic meaning into the feature block. Examples of semantic information captured for semantic blocks are illustrated and discussed below in conjunction with FIG. 8. For example, when the flow in a pipe decreases at a rate that exceeds a given threshold, and the temperature in a reaction chamber increases at a particular rate, it may indicate that the efficiency within a certain reaction chamber is decreasing. The semantic label can include the semantic meaning (e.g., an efficiency decrease within the reaction chamber) and optionally any conditions, patterns, values and/or other relevant information (e.g., the flow is decreasing and the temperature is increasing and optionally any thresholds, such as flow decreasing faster than a particular rate). An example of the semantic label(s) that describe the characteristics would be the second part of the above (e.g., a description of the patterns of the feature blocks along with any conditions if desired) or any other such description.

Operation 726 captures any additional required and/or optional attributes. Examples of required and/or optional attributes are discussed below in conjunction with FIG. 8.

Operation 730 outputs the semantic block to a data store such as a triple store or other store for later retrieval and/or analysis. Additionally, or alternatively, the system can send the semantic blocks to another program, method, system, and so forth. Thus, the semantic blocks are indexed for semantic search in some embodiments of the disclosure. After operation 730, the system checks for more data, if any, in operation 718.

FIG. 8 represents an example of information (e.g., features, attributes, characteristics and so forth) in a semantically annotated block 800 (also referred to as a semantic block) in a representative embodiment. The information can be variously referred to as “features,” “properties,” “attributes” and so forth. The features illustrated in semantic block 800 can be either optional or required in various embodiments. Typically, although not always, required features comprise some combination of identification of the source of the data, the time segment of the semantic block, and the semantic features. Typically, although not always, optional features comprise information that describe the patterns.

Features that identify the source of the data (e.g., feature blocks and/or time-series data) can be any type if identifying information that describes where the data comes from. For example, one way to describe the data is by reference to the underlying time-series data. Another way is by reference to the feature-blocks of the time-series data. In the representative example of FIG. 8, the features that identify the source of the data reference the underlying time-series data. Thus, these features comprise a location ID 804, which describes the location of the sensor such as a machine or unit ID (e.g., turbine 05), location within the system (e.g., inlet steam temperature sensor 2), and/or any other such identifying information. The features that identify the source of the data also comprise sensor ID 806, which is an identifier for the particular sensor(s) that generated the time-series data. Note that since semantic blocks typically reference multiple time-series data, there will be multiple such location identifiers, sensor identifiers, and so forth. There can also be specific identifiers associated with the time-series data that are part of this set of features, if desired. In other embodiments, rather than reference the underlying time-series data, reference is made to the feature blocks and identifiers associated with the feature blocks are used. In such embodiments, if reference is made to the feature blocks, the underlying time-series data information can be extracted from the referenced feature blocks.

Features that identify the time segment of the semantic block can comprise any identifiers that define where the block is located within the time-series data and/or the feature blocks (as appropriate). In some embodiments, if reference is made to the feature blocks, the underlying time-series data information can be extracted from the feature blocks. When reference is made to the underlying time-series data, for example, a time reference, a sample number or any other such identifier can be used. An example is a start time along with a duration and/or end time. In the representative example of FIG. 8, the features that identify the time segment comprise the start time(s) 808 and the end time(s) 810. Since multiple time-series data are used as the foundation for semantic blocks (either directly or via feature blocks), the various time segments of the various time-series data are included so the start/stop times will be for multiple segments. Alternatively, multiple feature blocks can be referenced by identifier and/or other reference. The time-series start/stop times can be retrieved from the feature blocks if desired.

Semantic features are represented in the example of FIG. 8 by semantic ID 802, semantic information 812 and semantic attributes 814. Not all of these are utilized in all embodiments and embodiments may use one, some, all or none. Semantic features have been discussed above and may comprise information that contains semantic meaning and/or information that describes semantic patterns, conditions and so forth.

The semantic ID 802 is a label, identifier, or other such designation for the semantic block. It may, for example, be an identifier of (e.g., an identifier that describes) the semantic model (e.g., pattern) that produced the semantic block. In some embodiments, reference to the semantic pattern is sufficient to describe the underlying patterns that form the basis for the semantics of the semantic block. Alternatively, or additionally, reference to feature blocks can be sufficient to describe the patterns if the feature blocks contain descriptors for the feature patterns. Thus, if the semantic block is created from a feature block with a rising pattern from a temperature sensor and a feature block with a rising pattern for a pressure sensor, reference to those blocks may be sufficient to obtain the desired pattern information.

Semantic meaning is illustrated in FIG. 8 by semantic information 812. Examples presented above illustrate how semantic meaning can be represented such as by indicating a drop in reactor efficiency (when flow drops and temperature increases). In this example, the drop in efficiency would be the semantic meaning. Semantic information 812 is any information that represents semantic meaning. This semantic information may be encoded in any desired fashion, such as where IDs indicate domain specific semantic information, by using text strings, or in any other fashion.

If patterns and/or conditions are attached to the semantic meaning, to the extent that this information is not specified by other references, semantic attributes 814 represents that information. Thus, in the reactor efficiency example above, when the flow in a pipe decreases at a rate that exceeded a given threshold, and the temperature in a reaction chamber rises at a particular rate, the efficiency within the reaction chamber decreases. The semantic meaning includes the reduced efficiency within the reaction chamber. The semantic attributes would specify the conditions, patterns, values and/or other relevant information associated with the semantic meaning. In this example, the flow is decreasing and the temperature is increasing along with any desired threshold information. If reference is made to the feature blocks, this information may be retrieved from the feature blocks to the extent it resides therein.

In FIG. 8, other feature 816 represents any additional features (optional and/or required) that are included in the semantic block.

Note that different embodiments may be implemented in different ways so that data cleaning modules, workflow steps, and so forth may not be executed on the same physical and/or virtual system, but may be spread across machines in a distributed manner. Similarly, various aspects are implemented in the cloud and/or as a service in some embodiments.

### Modules, Components and Logic

The embodiments above are described in terms of modules. Modules may constitute either software modules (e.g., code embodied (1) on machine-readable medium or (2) in a transmission medium as those terms are described below) or hardware-implemented modules. A hardware-implemented module is a tangible unit capable of performing certain operations and may be configured or arranged in a certain manner. Hardware modules are configured either with hardwired functionality such as in a hardware module without software or microcode or with software in any of its forms (resulting in a programmed hardware module) or with a combination of hardwired functionality and software. In example embodiments, one or more computer systems (e.g., a standalone, client or server computer system, cloud environment, computing devices and so forth) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations to result in a special purpose or uniquely configured hardware-implemented module. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein are at least partially processor-implemented. For example, at least some of the operations of a method may be performed by one or more processors or processor-implemented modules. The performance of certain operations may be distributed among the one or more processors, not only residing within a single machine, but deployed across a number of machines. In some example embodiments, the processor or processors may be located in a single location (e.g., within a home environment, an office environment or as a local server farm or in a cloud environment), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures may be employed. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

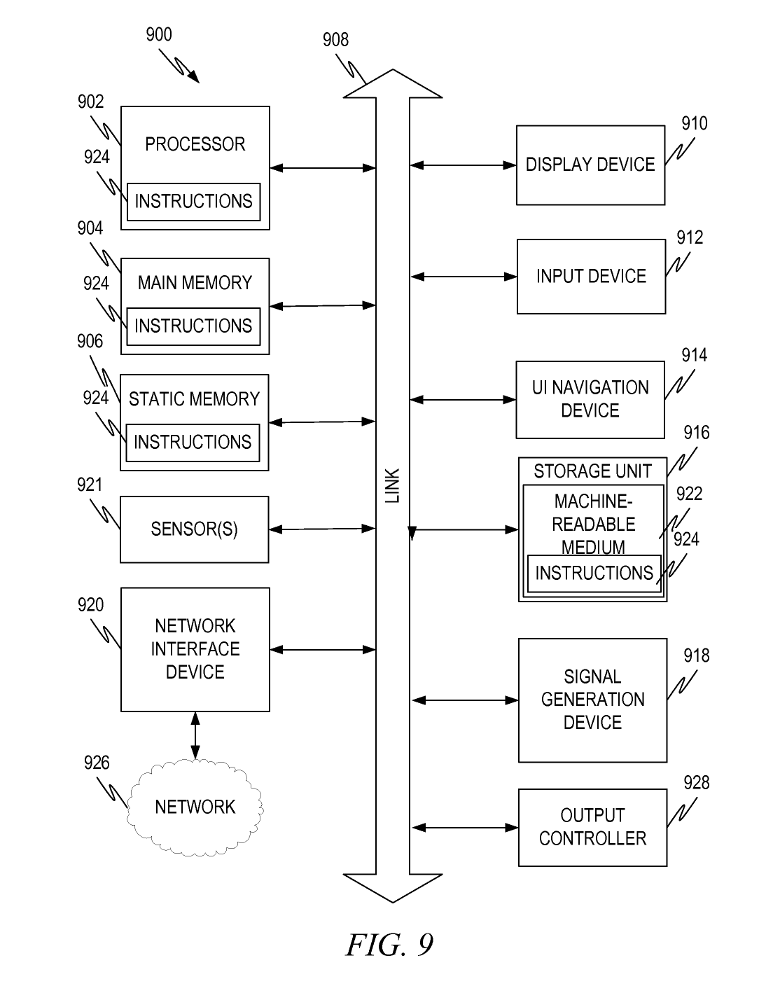

FIG. 9 is a block diagram of a machine in the example form of a processing system within which may be executed a set of instructions for causing the machine to perform any one or more of the methodologies discussed herein including the functions, systems and flow diagrams of FIGS. 1-8. Said another way, the representative machine of FIG. 9 implements the modules, methods and so forth described above in conjunction with the various embodiments.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment to implement the embodiments described above either in conjunction with other network systems or distributed across the networked systems. The machine may be a personal computer (PC), a tablet PC, a set-top box (STB), a personal digital assistant (PDA), a cellular telephone, a smart phone, a tablet, a wearable device (e.g., a smart watch or smart glasses), a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the machine 900 includes at least one processor 902 (e.g., a central processing unit (CPU), a graphics processing unit (GPU), advanced processing unit (APU), or combinations thereof), a main memory 904 and static memory 906, which communicate with each other via link 908 (e.g., bus or other communication structure). The machine 900 may further include graphics display unit 910 (e.g., a plasma display, a liquid crystal display (LCD), a cathode ray tube (CRT), and so forth). The machine 900 also includes an alphanumeric input device 912 (e.g., a keyboard, touch screen, and so forth), a user interface (UI) navigation device 914 (e.g., a mouse, trackball, touch device, and so forth), a storage unit 916, a signal generation device 928 (e.g., a speaker), sensor(s) 921 (e.g., global positioning sensor, accelerometer(s), microphone(s), camera(s), and so forth) and a network interface device 920.

### Machine-Readable Medium

The storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904, the static memory 906, and/or within the processor 902 during execution thereof by the machine 900. The main memory 904, the static memory 906 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. The term machine-readable medium specifically excludes non-statutory signals per se.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Transmission medium encompasses mechanisms by which the instructions 924 are transmitted, such as communication networks. Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine 900 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A device comprising hardware processing circuitry configured to at least:
retrieve time-series data measured from at least one sensor;
retrieve feature models describing possible features of the time-series data;
evaluate the time-series data against the retrieved feature models to identify a start time for at least one feature contained in the time-series data;
create a feature block of the time series data, the feature block comprising a first set of identifying information, the first set of identifying information comprising at least one of:
an equipment identifier;
a sensor identifier;
the start time;
at least one descriptive label describing semantics for the feature block; and
feature model identifying information descriptive of the feature block relative to at least one feature model; and
store the feature block.

2. The device of claim 1 wherein the hardware processing circuitry is further configured to create a second feature block that overlaps the feature block in time.

3. The device of claim 1, wherein the hardware processing circuitry is further configured to create a second feature block that does not overlap the feature block in time.

4. The device of claim 1, wherein the identifying information further comprises at least one of either a end time or a duration.

5. The device of claim 1, wherein the retrieved feature models comprises at least one of:
a steady-state feature model;
an increasing feature model;
a decreasing feature model; and
an oscillating feature model.

6. The device of claim 5, wherein:
the feature model identifying information descriptive of the feature block relative to the steady-state feature model comprises a steady-state value;
the feature model identifying information descriptive of the feature block relative to the increasing feature model comprises a slope value defining an increase in value;
the feature model identifying information descriptive of the feature block relative to the decreasing feature model comprises a slope value defining a decrease in value; and
the feature model identifying information descriptive of the feature block relative to the oscillating feature model comprises at least one frequency value describing the frequency of oscillation and one amplitude value describing the size of the oscillation.

7. The device of claim 1, wherein the first set of identifying information further comprises second feature model identifying information descriptive of the feature block relative to a second feature model.

8. The device of claim 1, wherein the hardware processing circuitry is further configured to:
access stored feature blocks derived from time-series data from a plurality of sensors;
access semantic models describing semantics related to the time-series data from the plurality of sensors;
identifying at least one semantic label descriptive of at least one feature block derived from time-series data from one of the plurality of sensors and at least one second feature block derived from time-series data from a second of the plurality of sensors;
creating at least one semantic block comprising a second set of identifying information, the second set of identifying information comprising at least one of:
the at least one semantic label;
identifying information descriptive of the time-series data from the one of the plurality of sensors; and
identifying information descriptive of the time-series data from the second of the plurality of sensors; and
store the at least one semantic block.

9. A method performed by a device to create a semantic index for time-series data, the method comprising:
retrieving time-series data measured from at least one sensor;
retrieving feature models describing possible features of the time-series data;
evaluating the time-series data against the retrieved feature models to identify a start time for at least one feature contained in the time-series data;
creating a feature block of the time series data, the feature block comprising a first set of identifying information, the first set of identifying information comprising at least one of:
an equipment identifier;
a sensor identifier;
the start time;
at least one descriptive label describing semantics for the feature block; and
feature model identifying information descriptive of the feature block relative to at least one feature model; and
storing the feature block.

10. The method of claim 9 wherein the method further creates a second feature block that overlaps the feature block in time.

11. The method of claim 9, wherein the method further creates a second feature block that does not overlaps the feature block in time.

12. The method of claim 9, wherein the method creates a plurality of feature blocks and the method further comprises creating an index of the plurality of feature blocks.

13. The method of claim 9, wherein the retrieved feature models comprises at least one of:
a steady-state feature model;
an increasing feature model;
a decreasing feature model; and
an oscillating feature model; and
wherein the feature model identifying information is descriptive of at least one of:
the steady-state feature model;
the increasing feature model;
the decreasing feature model; and
the oscillating feature model.

14. The method of claim 9, wherein the first set of identifying information further comprises second feature model identifying information descriptive of the feature block relative to a second feature model.

15. The method of claim 12, wherein at least one of the plurality of feature blocks comprises feature model identifying information descriptive of a plurality of feature models and the method further comprises creating an index of the plurality of feature blocks.

16. A computer storage medium comprising computer executable instructions that when executed configure a device to at least:
retrieve time-series data measured from at least one sensor;
retrieve feature models describing possible features of the time-series data;
evaluate the time-series data against the retrieved feature models to identify a start time for at least one feature contained in the time-series data;
create a feature block of the time series data, the feature block comprising a first set of identifying information, the first set of identifying information comprising at least one of:
an equipment identifier;
a sensor identifier;
the start time;
at least one descriptive label describing semantics for the feature block; and
feature model identifying information descriptive of the feature block relative to at least one feature model; and
storing the feature block.

17. The computer storage medium of claim 16 wherein the computer executable instructions further configure the device to create a second feature block that overlaps the feature block in time.

18. The computer storage medium of claim 16 wherein the computer executable instructions further configure the device to create a second feature block that does not overlaps the feature block in time.

19. The computer storage medium of claim 16 wherein the computer executable instructions further configure the device to create a plurality of feature blocks at least some of which overlap in time and at least some of which do not overlap in time.

20. The computer storage medium of claim 16 wherein the computer executable instructions further configure the device to create a plurality of feature blocks and create an index of the plurality of feature blocks.
